(19) United States
(12) Patent Application Publication
(10) Pub. No.: US 2005/0118395 A1
(43) Pub. Date: Jun. 2, 2005

(54) Joint-cover rubber strip for preparing and painting two adjacent surfaces separated by a hollow joint

(76) Inventor: Daniel Cortavitarte Perez, Corver de Asturias (ES)

Correspondence Address: Robert Platt Bell, 8033 Washington Road, Alexandria, VA, 22308, US

(21) Appl. No.: 10/250,690

(22) PCT Filed: Jan. 18, 2002
(86) PCT No.: PCT/ES02/00022

(30) Foreign Application Priority Data
Jan. 19, 2001 (ES) U200100135

(51) Int. Cl. B05D 5/12; B05C 13/00; B41N 1/24

(52) U.S. Cl. 428/156; 427/115; 427/142; 118/504

(57) ABSTRACT

A Joint-cover rubber strip for preparing and painting two adjacent surfaces separated by a hollow joint, comprises a single-piece body 2 having a horizontal rectangular face 4 at one end which is parallel to another wider face 18. One of the faces 4 is defined by two inclined rectangular surfaces 3 and 5 and the other face 18 is provided with two inclined sides 16 and 17. The whole strip comprises a single-piece elastomer body disposed in the center of two projecting parts 8 and 9.

### CROSS-REFERENCE TO RELATED APPLICATIONS

The present application is a §371 NATIONAL PHASE Application of PCT/SE02/00022, filed on Jan. 18, 2002, which in turn claims priority from Spanish Patent Application Serial Number U200100135 filed on Jan. 19, 2001, both of which are incorporated herein by reference.

### FIELD OF THE INVENTION

The present invention is directed toward the industry dedicated to the manufacture of accessories, devices, and elements for the protection of surfaces such as joints, tapes, bands, and the like during painting and other finishing processes.

### BACKGROUND OF THE INVENTION

Within the industry dedicated to the painting or repair of surfaces, such as the painting or the repair treatment of the surfaces of the bodywork of automobile vehicles, pieces of border tape (e.g., masking tape or the like) are often used, bending the edges so as not to expose the paint to the creation of borders and to make it possible to prepare and paint the parts to the very edge of the surfaces that are to be painted. Such tapes, however, are difficult to apply and must be disposed of after each use.

As a substitution of the above-mentioned border tape, other strips provided with magnetic material on their opposite faces may be used, with greater or lesser success, as well as cardboard, paper, and the like.

FIG. 4C illustrates a scheme with the prior art form and the edge of the adjacent surface in such case without a defined protected area in the vertex 24 between adjacent edges 21 and 22.

Obviously, the quality of these Prior Art devices is not optimum and consequently, the time used in placing them is substantial, which implies an increase in general operation costs or in the dedication of many hours to the preparation of the areas to be repaired, apart from the cost of the materials themselves.

Thus, it remains a requirement in the art to provide an apparatus which adequately and hermetically seals the gap that exists between the two surfaces, being capable of adapting to the different thicknesses and hermetically sealing the gaps to prevent the entrance of particles or paint to the interior by having an element capable of exercising the relevant pressure on the walls of the joint, but not overlapping the surface that is to be treated. It also remains a requirement in the art to provide an apparatus which may be cleaned after use, to restore it to such conditions that permit its reuse.

However, prior to the development of the present invention, applicant had no knowledge of the existence of an invention that includes the ideal features mentioned above.

### SUMMARY OF THE INVENTION

The joint-cover rubber strip for preparing and painting two adjacent surfaces separated by a hollow joint proposed by the invention is, in itself, an obvious novelty that allows the performance of the surface preparation and painting of two adjoining surfaces, without any possibility of any external material passing to the interior of the joint that is being protected (i.e., overspray or the like).

More specifically, joint-cover rubber strip to preparing and painting two adjacent surfaces separated by a hollow joint object of this invention is based on a single-piece body manufactured of elastomeric material; its perimeter includes a number of features, allowing the adaptation of one side or of its opposite side to joints of different thicknesses, having practically in its central area two angular projections that generate two diagonally rectangular faces, thanks to which the surface preparation of the surface to be treated can be performed to the very edge that is being protected.

The joint-cover rubber strip is introduced in the existing joints between two adjacent surfaces and prevents the areas to be treated both vertically and horizontally and, consequently, prevents the access of any material to the interior of the joints.

### BRIEF DESCRIPTION OF THE DRAWINGS

As a complement to the description being presented and for a better understanding of the specifications of the invention, one page of drawings is attached to this descriptive memory, where the following elements are displayed with an informative but not a limiting intention.

FIG. 1 is a perspective view of the preferred embodiment of the present invention, concerning a joint-cover rubber strip for preparing and painting two adjacent surfaces separated by a hollow joint.

FIG. 2 illustrates as an example, the side of an automobile vehicle on which the preferred embodiment of the present invention displayed in FIG. 1 has been installed, protecting the existing joints between the doors of a vehicle.

FIG. 3 is a cross-sectional view along line A-B as illustrated in FIG. 2.

FIG. 4A illustrates a scheme with a simple form of the joint-cover with less angular faces disposed in the hollow joint having the external side below and the inner one above and one of the edges to be painted forming an angle with the joint-cover.

FIG. 4B illustrates a scheme with a simple form of the joint cover of FIG. 3, with the joint-cover with less angular faces having the external and inner side as in FIG. 4A, but with a pair of side protrusions disposed in the hollow joint to displace the protected surface in the vertex.

FIG. 4C illustrates a scheme with the prior art form and the edge of the adjacent surface in such case without a defined protected area in the vertex.

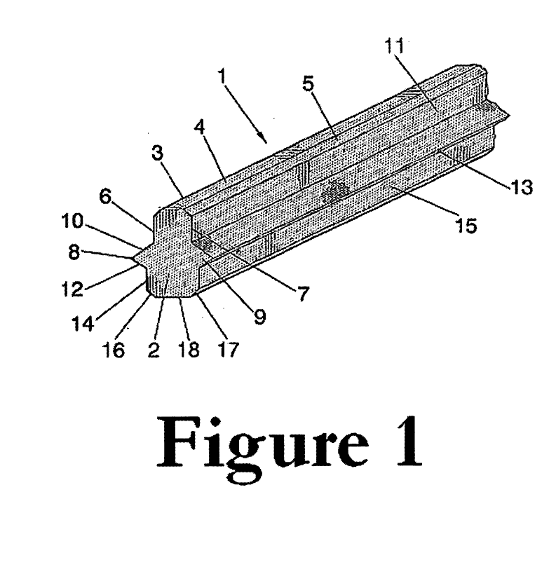

### DETAILED DESCRIPTION OF THE INVENTION

In view of the Figures, it can be seen how the joint-cover rubber strip 1 for preparing and painting of two adjacent surfaces 21 and 22 separated by a hollow joint, is made up from a single-piece body 2 which presents on a top surface, a configuration of three faces or facets, 3, 4, and 5. Faces or facets 3 and 5 are situated diagonally and face or facet 4 horizontally, presenting after faces and facets 3 and 5, two vertical and parallel areas 6 and 7.

From the inferior edges of parallel edges 6 and 7, two prolongations extend 8 and 9, presenting inclined or diagonal faces 10 and 11 at the top and 12 and 13 at the bottom, consequently allowing access to the edge formed by faces 7 and 11 or by the existing edges between faces 6 and 10.

At the bottom, although of a lesser width, body 2 represents a configuration similar to the one described above, having an horizontal face 18 parallel to face 4, and two diagonal side faces 16 and 17 situated in a similar way as faces 3 and 5 that protrude from the central area or facet 4.

There are also vertical facets or faces 14 and 15 which are similar to faces or facets 6 and 7 although as they are configured in a thicker area they present a larger separation to the one that exists between faces 6 and 7, in order to fit into joints with a greater or lesser width.

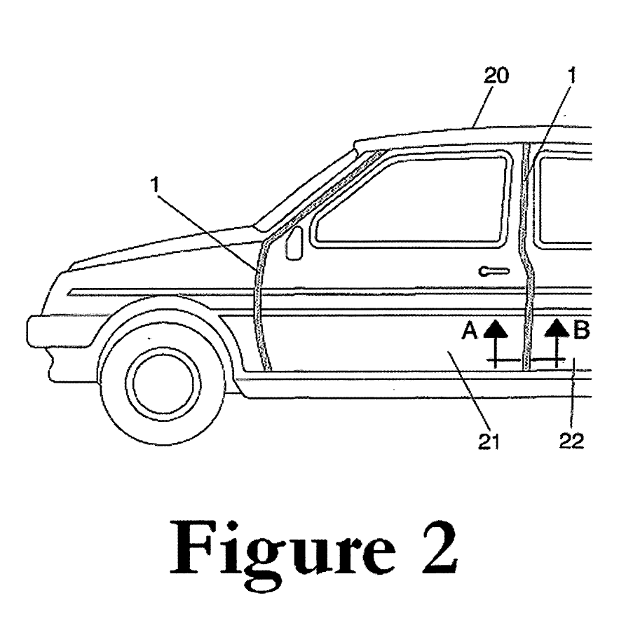

Continuing with FIG. 2, it can be seen that on a vehicle 20 with doors 21 and 22 separated from each other by joints, joint-cover rubber strips 1 that hermetically seal the joint have been installed, permitting access of the painting or preparation of the surface through sloped portions 30 and 31, stemming from the existence of faces 10 and 11. The body of the joint-cover rubber strip has been introduced inside the joints occupying faces 3, 4, 5, 6, and 7.

It is not considered necessary to extend this description as to any one of ordinary skill in the art may understand the invention field and the advantages resulting from it.

Materials, form, size and elements disposal will be subject to variation, provided that they do not involve an alteration of the essentiality of the invention.

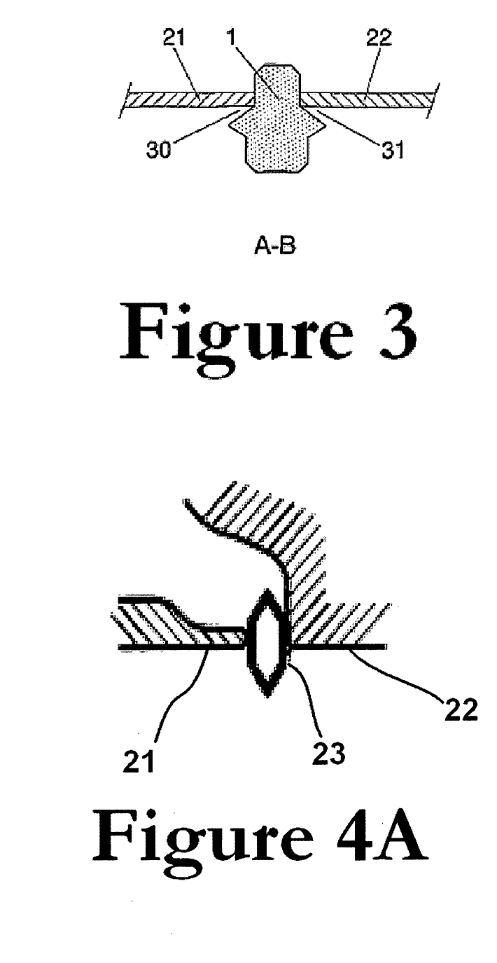

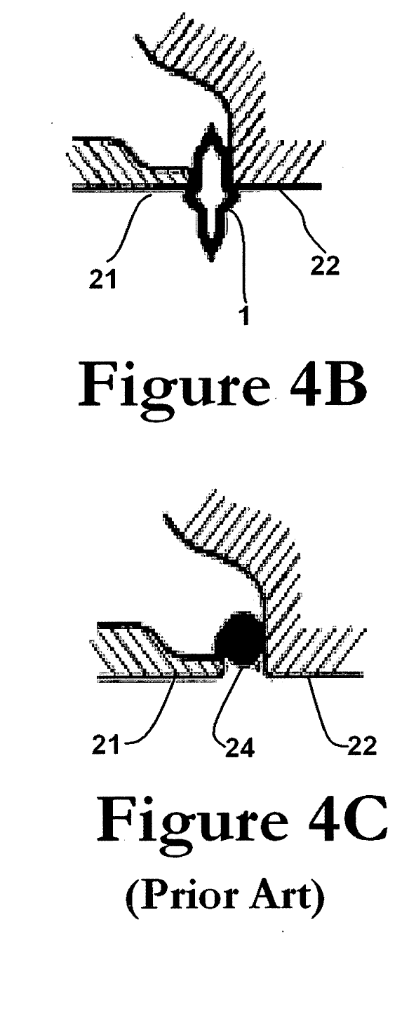

FIG. 4A illustrates a scheme with a simple form of the apparatus of FIG. 3, with the joint-cover with less angular faces disposed in the hollow joint having the external side below and the inner one above and one of the edges 21 and 22 to be painted forming an angle with the joint-cover 23. FIG. 4B illustrates a scheme with a simple form of the apparatus 1 of FIG. 3, with the joint-cover with less angular faces having the external and inner side as in FIG. 4A, but with a pair of side protrusions disposed in the hollow joint to displace the protected surface in the vertex.

While the preferred embodiment and various alternative embodiments of the invention have been disclosed and described in detail herein, it may be apparent to those skilled in the art that various changes in form and detail may be made therein without departing from the spirit and scope thereof.

1. A joint-cover rubber strip for preparing and painting two adjacent surfaces separated by a hollow joint, comprising:
a single-piece elastomeric body (2) that presents, on one of its ends a horizontal rectangular face (4), situated parallel to a wider face (18), whose face (4) is limited by two inclined rectangular surfaces (3) and (5), while the opposite face (18) presents inclined faces (16) and ( 17) on its side which are joined to the faces (3) and (5) in order to be used with the wider part of the piece (18) situated between the faces (16) and (17) as a projecting body sticking out of the hollow joint in the external side of the plane of the two adjacent surfaces (21) and (22), and with the body of the joint-cover rubber strip as introduced inside the joints occupying faces (3), (4), (5) (6) and (7) such that the surface preparation of the surface to be treated to the very edge of the two adjacent surfaces that are to he painted, thus improving the preparation and painting finish quality in the edge of both adjacent surfaces.

2. Joint-cover rubber strip for preparing and painting two adjacent surfaces separated by a hollow joint, comprising:
a single-piece elastomeric body (2) that presents, on one of its sides, a horizontal rectangular face (4), situated parallel to a wider face (18), whose face (4) is limited by two inclined rectangular surfaces (3) and (5), while the wider face (18), presents inclined face (16) and (17) on its side,
where the single-piece elastomeric body (2) presents, in a central lateral area, two prolongations (8) and (9), made up of coinciding inclined faces, where a top pair (10) and (11) are rectangular, the same as a bottom pair (12) and (13).

3. Join-cover rubber strip for preparing and painting two adjacent surfaces separated by a hollow joint, according to claim 2, further comprising vertical and parallel faces (6) and (7) between an internal edge formed by faces (10) and (11) with the external edge of faces (3) and (5)

4. Joint-cover rubber strip for preparing and painting two adjacent surfaces separated by a hollow joint, according to claim 3, further comprising vertical and parallel faces (14) and (15) between the internal edge of the faces (12) and (13) and the external edges of the faces (16) and (17).

5. Joint-cover rubber strip fir preparing and painting two adjacent surfaces separated by a hollow joint, according to claim 4, wherein a thickness of the body (2) between faces (14) and (15) is considerably bigger than that which exists between vertical and parallel faces (6) and (7).

6. (canceled)

7. A joint-cover elastomeric strip for preparing and painting two adjacent surfaces separated by a hollow joint, said joint-cover elastomeric strip comprising a single-piece linear elastomeric body having:
on a top side of the linear elastomeric body, first substantially flat surface,
on a bottom side of the linear elastomeric body, a second substantially flat surface wider than the first substantially flat surface,
adjacent the first substantially flat surface, a first pair of beveled substantially flat surfaces, and
adjacent the second substantially flat surface, a second pair of beveled substantially flat surfaces,
where the elastomeric body further includes:
in a pair of central lateral areas adjacent to and between the top side and the bottom side of the linear elastomeric body, a pair of protrusions, each made up of a pair of coinciding inclined substantially flat surfaces, each of the pair of coinciding inclined surfaces joining together at one edge.

8. The joint-cover elastomeric strip for preparing and painting two adjacent surfaces separated by a hollow joint, according to claim 7, further including substantially flat and parallel faces between the pairs of protrusions and the top side and the bottom side.

9. The joint-cover elastomeric strip for preparing and painting two adjacent surfaces separated by a hollow joint, according to claim 7, further including substantially flat and parallel faces between the pairs of protrusions and the top side and the bottom side.

10. The joint-cover elastomeric strip for preparing and painting two adjacent surfaces separated by a hollow joint, according to claim 7, wherein the linear elastomeric body has a thickness on a top side portion of the pair of protrusions smaller than on the bottom side portion of the pair of protrusions.

11. The joint-cover elastomeric strip for preparing and painting two adjacent surfaces separated by a hollow joint, according to claim 7, wherein the linear elastomeric body has a thickness on a top side portion of the pair of protrusions smaller than on the bottom side portion of the pair of protrusions.

12. The joint-cover elastomeric strip for preparing and painting two adjacent surfaces separated by a hollow joint, according to claim 8, wherein the linear elastomeric body has a thickness on a top side portion of the pair of protrusions smaller than on the bottom side portion of the pair of protrusions.

13. The joint-cover elastomeric strip for preparing and painting two adjacent surfaces separated by a hollow joint, according to claim 9, wherein the linear elastomeric body has a thickness on a top side portion of the pair of protrusions smaller than on the bottom side portion of the pair of protrusions.

14. (canceled)

15. A method of preparing and painting a surface having at least two adjacent surfaces separated by at least one hollow joint, and method comprising the step of:
inserting into the at least one hollow joint, a linear elastomeric strip, the linear elastomeric strip having at least one portion wider than the at least one hollow joint such that the linear elastomeric strip, when inserted into the hollow joint, is compressed by the hollow joint and retained therein,
wherein the linear elastomeric strip has is provided with a pair of protrusions on each side of the linear elastomeric strip, and the method further comprises the step of placing the linear elastomeric strip in the at least one hollow joint such that the protrusions rest within the at least one hollow joint so as to prevent overspray from entering the hollow joint.

16. The method of claim 15, wherein the linear elastomeric strip is provided with a first portion having a first thickness in cross-section and a second portion having a second thickness in cross-section, said method further comprising the step of selecting from the first and second portions, a thickness larger than a thickness of the at least one hollow joint, such that when the linear elastomeric strip is inserted into the hollow joint, is compressed by the hollow joint and retained therein.

17. The method of claim 15, further comprising the step of preparing and painting the at least two adjacent surfaces after insertion of the linear elastomeric strip into the at least one hollow joint.

18. The method of claim 17, further comprising the step of removing the linear elastomeric strip from the at least one hollow joint after completion of preparing and painting of the two adjacent surfaces to expose the at least one hollow joint unpainted.

19. The method of claim 18, further comprising the step of cleaning paint from the linear elastomeric strip and reusing the linear elastomeric strip.

20. The method of claim 18, wherein the at least two adjacent surfaces comprise external automobile body surfaces, and the at least one hollow joint comprises at least one of an automobile door, trunk lid, or hood joint, and the linear elastomeric strip is provided with a thickness corresponding to at least one of the automobile door, trunk lid, or hood joints.

21. The joint-cover rubber strip for preparing and painting two adjacent surfaces separated by a hollow joint, according to claim 1, where the elastomeric body (2) is characterized, in the central lateral area, by two prolongations (8) and (9), made up of coinciding inclined faces on an external view, where the top ones (10) and (11) are rectangular, the same as a bottom pair (12) and (13), to displace few millimeters toward the external side the edge of the preparation and painting from the vertex of both adjacent surfaces (21) and (22).

22. The joint-cover rubber strip for preparing and painting two adjacent surfaces separated by a hollow joint, according to claim 21, wherein by having two vertical and parallel inner faces (6) and (7) between the inclined rectangular faces (3) and (5) and the lower faces (10) and (11) which form the underside of the prolongations (8) and (9), to improve the full occupation of the hollow joint by the inner part of the strip.

23. The joint-cover rubber strip for preparing and painting two adjacent surfaces separated by a hollow joint, according to claim 22, characterized by having two vertical and parallel outer faces (14) and (15), between the inclined rectangular faces (16) and (17) and the upper faces (12) and (13) which form the upside of the prolongations (8) and (9), to make easier the handling of the external part of the strip in the hollow joint.

24. The joint-cover rubber strip for preparing and painting two adjacent surfaces separated by a hollow joint, according to claim 23, wherein the thickness of the body (2) between faces (14) and (15) which is considerably bigger than that which exists between vertical and parallel faces (6) and (7) to make easier the handling of the strip.
